(19) United States
(12) Patent Application Publication
(10) Pub. No.: US 2011/0134724 A1
(43) Pub. Date: Jun. 9, 2011

(54) SYSTEM AND METHOD FOR CONCURRENT BATHYMETRIC FIX

(75) Inventor: Steven Kelmenson, Hicksville, NY (US)

(73) Assignee: Lockheed Martin Corporation, Bethesda, MD (US)

(21) Appl. No.: 12/633,244

(22) Filed: Dec. 8, 2009

(51) Int. Cl. G01S 15/08

(52) U.S. Cl. 367/99

(57) ABSTRACT

A system and method operate a Navigation Sonar System in an Alert Velocity Submode, receive sonar data during the operation of the Navigational Sonar System in the Alert Velocity Submode, and use the sonar data to compute depth data used to calculate a Bathymetric Fix.

### TECHNICAL FIELD

The present disclosure relates to sonar systems, and in an embodiment, but not by way of limitation, a sonar system that computes a Concurrent Bathymetric Fix, which is a Bathymetric Fix that is calculated during Alert Velocity Submode (AVS) operation of a Navigation Sonar System (NSS).

### BACKGROUND

Navigation Sonar Systems (NSS) employ two distinct and mutually exclusive modes of operation—Alert Velocity Submode (AVS) and Depth Mode. The AVS generates a Receive Pulse Start (RPS) time (see FIG. 1), and the AVS uses the RPS time to begin the process of developing estimates of ship's speed over ground, and north and east velocity corrections. Depth Mode is used to collect data to determine Depth Below Keel (DBK), which when used in conjunction with Keel Depth (KD), from a pressure depth sensor, is used to estimate Depth Below Surface (DBS). A group of DBS measurements, along with ocean survey reference map data, indicated position from the ship's Inertial Navigational System (INS), and a map matching algorithm, may be used to develop an estimate of the position error in the ship's INS. This error estimate, when resolved into latitude and a longitude, is referred to as a Bathymetric Fix, and it can be used to reset the ship's inertial navigator's position. A schematic of the Bathymetric Fix employing Depth Mode and its sonar depth measurements is illustrated in FIG. 2.

Some INS use velocity aiding in order to bound latitude error, reduce longitude error, and reduce north and east velocity error. It has recently been proposed to use velocity aiding (i.e., NSS speed over ground) in combination with a reduced accuracy INS to reduce reliance on a ship's INS (while maintaining overall navigational accuracy). The bounding of latitude error is illustrated at 310 on graph 300 of FIG. 3A. The latitude error in an INS that does not use velocity aiding is shown at 320. Similarly, FIG. 3B illustrates the extent to which velocity aiding reduces longitude error in graph 350 at 330, as contrasted with an INS without velocity aiding at 340.

Velocity aiding however requires almost continuous ground speed velocity in order to function properly. Consequently, in Navigation Sonar Systems that are used to provide velocity aiding, the use of Depth Mode is severely limited, and it may even be precluded. The inability to perform Depth Mode operations impacts the collection of depth data that is required for the development of a Bathymetric Fix.

Approaches described in this background section could be pursued, but are not necessarily approaches that have been previously conceived or pursued. Therefore, unless otherwise indicated herein, the approaches described in this background section are not prior art to the claims in this application and are not admitted to be prior art by inclusion in this background section.

### BRIEF DESCRIPTION OF THE FIGURES

FIG. 1 illustrates a position of a Receive Pulse Start Time in a Navigation Sonar System receive window.

FIG. 2 illustrates the Bathymetric Fix process employing Depth Mode of a Navigation Sonar System.

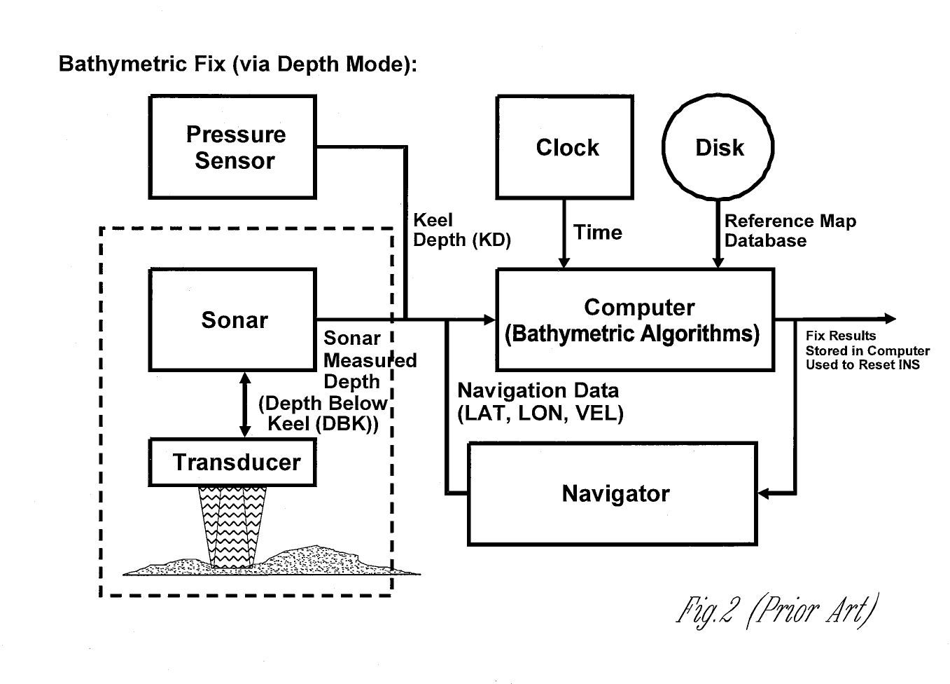

FIG. 3A is a graph illustrating the bounding of INS latitude error by velocity aiding.

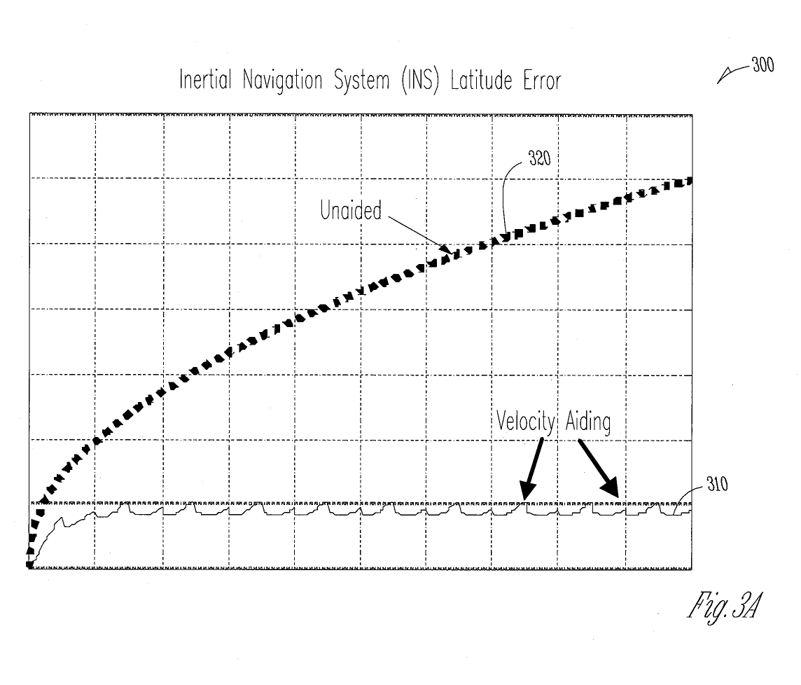

FIG. 3B is a graph illustrating the reduction of INS longitude error by velocity aiding.

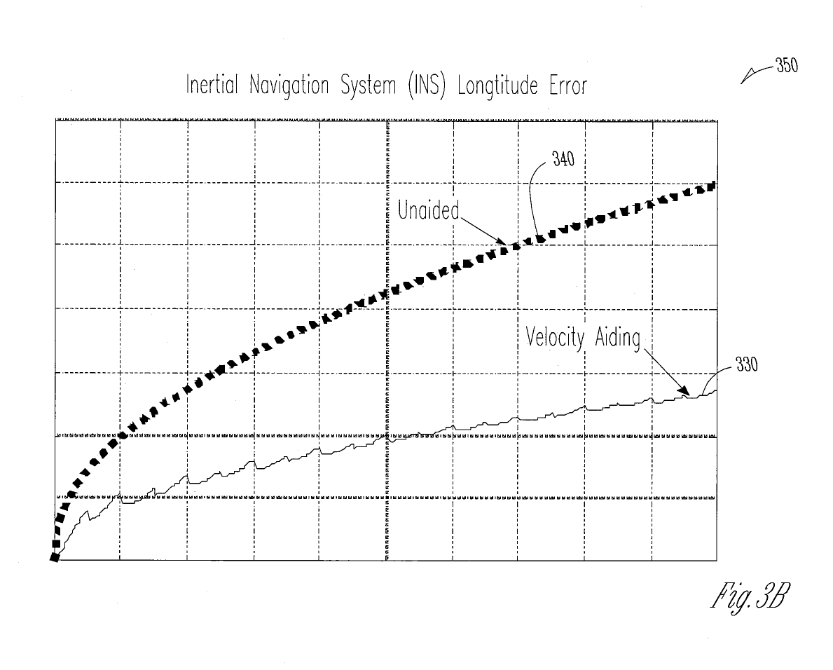

FIG. 4 illustrates how Receive Pulse Start (RPS) time can be used in place of Depth Mode to provide a Depth Below Keel (DBK) in the Concurrent Bathymetric Fix algorithm.

FIG. 5 is a flow chart illustrating an example embodiment of a process of generating a Concurrent Bathymetric Fix.

FIG. 6 illustrates an example embodiment of a computer processor, storage and transmission system that can form part of a Navigation Sonar System or be used in conjunction with a Navigation Sonar System.

### SUMMARY

In an embodiment, a system and method operate a Navigation Sonar System in Alert Velocity Submode, receive sonar data during the operation of the Navigation Sonar System in the Alert Velocity Submode, and use the sonar data to compute depth data required to calculate a Bathymetric Fix.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

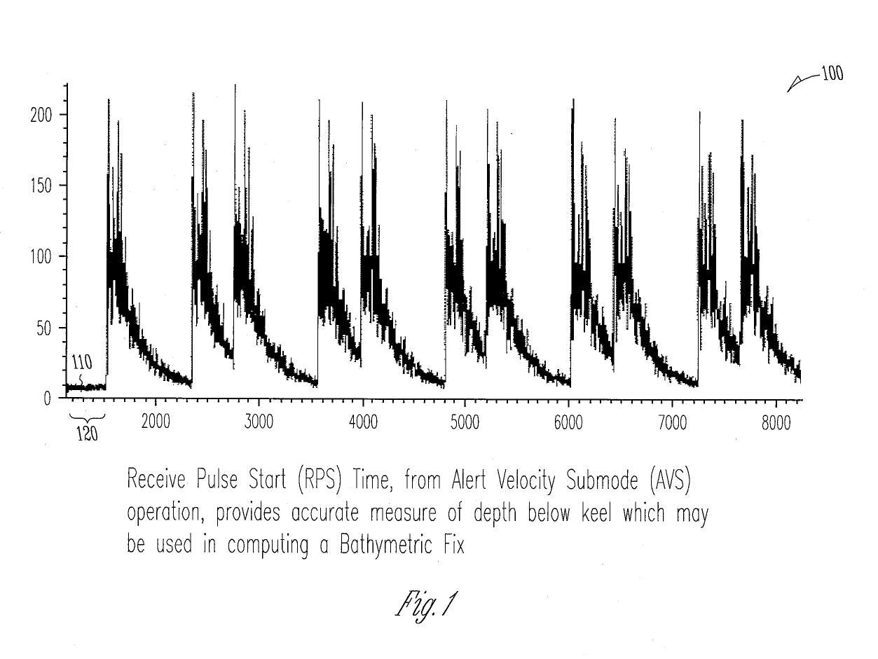

In order to develop a Bathymetric Fix, a sequence of bottom depths, INS indicated position, reference map data, and time of depth is needed. This data is available, or may be computed, while the NSS is operating in the Alert Velocity Submode (AVS), thus obviating the need for Depth Mode operation. Specifically, by tapping into a Navigation Sonar System's (NSS) process for identifying the leading edge of the first pulse in a sonar receive window (Receive Pulse Start (RPS) time) (See FIG. 1), depth data required for a Bathymetric Fix can be extracted during the NSS's Alert Velocity Submode (AVS) operation, and a Bathymetric Fix computed concurrently with AVS operation. Consequently, the near continuous operational nature of the AVS mode need not be interrupted.

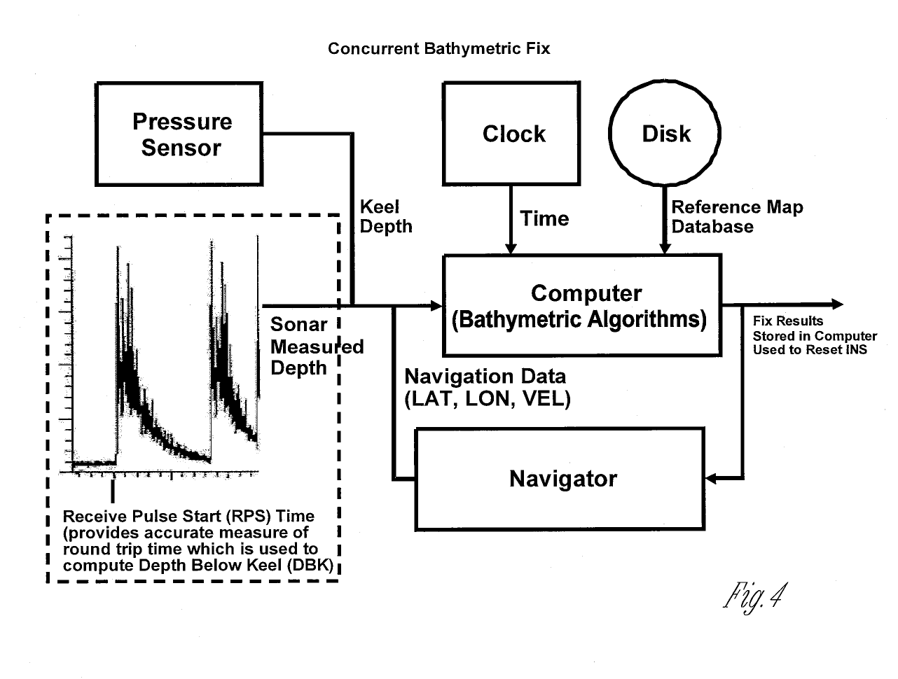

In an embodiment, each time that NSS is enabled, it performs an Automatic Depth Initialization (ADI), wherein the Sonar determines an approximate Depth Below Keel (DBK). The DBK is used to set a depth gate and an associated data collection period within which sonar pulse returns should appear. Upon completion of this data collection period, a correlation algorithm is used to determine the time of the leading edge of the first pulse return. This is referred to as Receive Pulse Start (RPS) time, and it is a refined estimate of the round trip time of the Sonar signal from the ship to the ocean bottom and back. FIG. 1 is a graph 100 illustrating such a first pulse return 110 and the RPS time 120. The RPS time may be used to accurately determine depth below keel by simply multiplying the RPS time by one-half the speed of sound in water. Then, the depth below keel is used to develop a Bathymetric Fix as shown in FIGS. 1 and 4. Each time the NSS is used in AVS to provide ground speed, many precise bottom depths will be generated that can be used concurrently to develop a Bathymetric Fix. Additionally, in the event AVS operations are terminated for an extended period of time, the system may be switched over to Depth Mode in order to complete the depth data collection required to support the Bathymetric Fix.

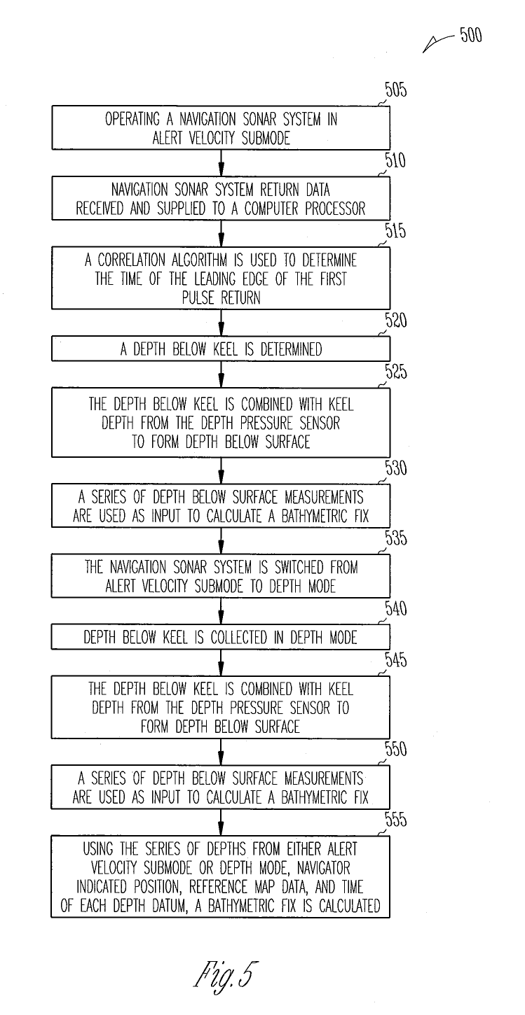

FIG. 5 illustrates a flowchart of an example embodiment of a process 500 to calculate a Concurrent Bathymetric Fix. FIG. 5 includes a number of process blocks 505-555. Though arranged serially in the example of FIG. 5, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring specifically to FIG. 5, the process 500 includes operating a Navigation Sonar System in an Alert Velocity Submode at 505. At 510, Navigation Sonar System sonar return data is received at a computer processor during the operation of the Navigation Sonar System in the Alert Velocity Submode. At 515, a correlation process is used to determine the location and time of the leading edge of the first pulse return.

Continuing with the process 500, at 520, a Depth Below Keel is determined, and at 525, the Depth Below Keel is combined with the Keel Depth to calculate a Depth Below Surface which is used as a measurement of bottom depth by the Bathymetric Fix algorithm. At 530, a series of these Depths Below Keel are determined, and when processed into Depth Below Surface, they are used to compute a Bathymetric Fix. At 535, the Navigation Sonar System is switched from Alert Velocity Submode into Depth Mode, and at 540, Depth Below Keel is collected via the traditional Depth Mode algorithm. At 545, the Depth Below Keel from Depth Mode is combined with Keel Depth to produce Depth Below Surface, and at 550, a series of these Depths Below Surface, whether produced via Alert Velocity Submode or Depth Mode, are used to calculate a Bathymetric Fix.

The process 500 continues at 555 by receiving at the computer processor of the Navigation Sonar System, while the Navigation Sonar System is operating in the Alert Velocity Submode or Depth Mode, measured and computed Depth Below Surface, a time at which each depth datum was acquired, an INS indicated position, and reference map data, and using the depth data, the INS indicated position, the reference map data, and the time of each depth datum to calculate the Bathymetric Fix.

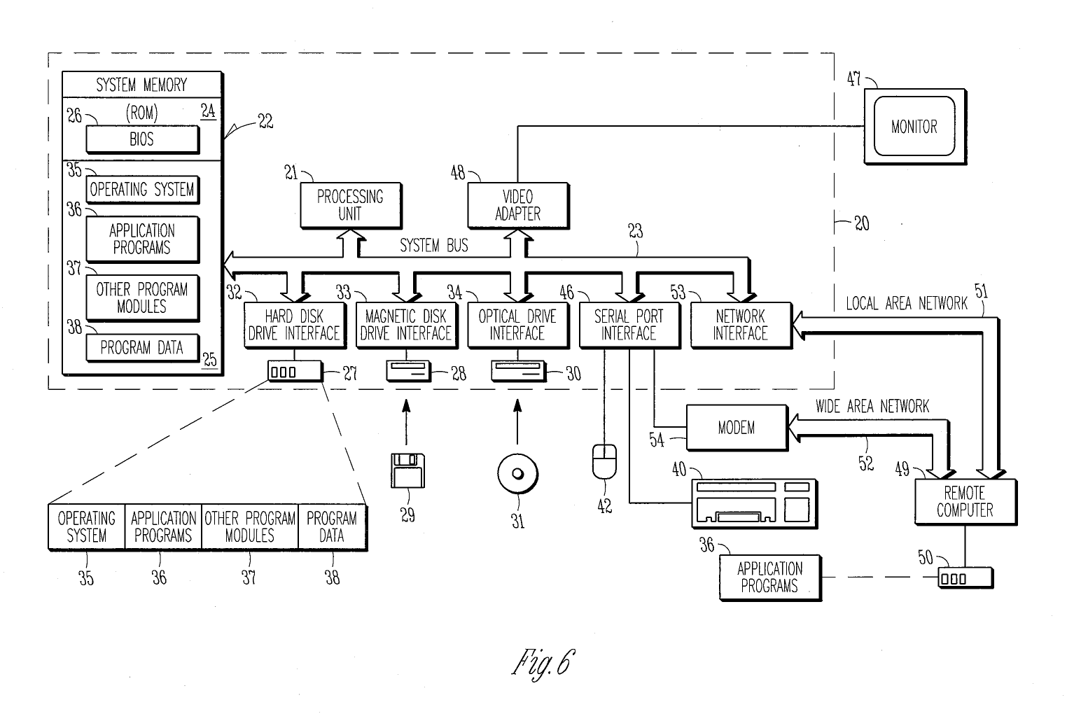

FIG. 6 is an overview diagram of a hardware and operating environment in conjunction with which embodiments of the invention may be practiced. The description of FIG. 6 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 6, a hardware and operating environment is provided that is applicable to any of the servers and/or remote clients shown in the other Figures.

As shown in FIG. 6, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 6 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Thus, an example system, method and machine readable medium for calculating a Concurrent Bathymetric Fix has been described. Although specific example embodiments have been described, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A process comprising:
operating a Navigation Sonar System in Alert Velocity Submode;
receiving at a computer processor of the Navigation Sonar System return data during the operation of the Navigation Sonar System in the Alert Velocity Submode; and
using depth data to calculate a Bathymetric Fix.

2. The process of claim 1, comprising:
using a correlation algorithm of the Alert Velocity Submode to identify a leading edge of a first pulse in a sonar window; and
using the leading edge to calculate Receive Pulse Start Time and the associated Depth Below Keel.

3. The process of claim 2, wherein the use of the algorithm comprises:
determining a Depth Below Keel;
using the Depth Below Keel and a Keel Depth to establish a Depth Below Surface; and
using a series of Depth Below Surface measurements from either the Alert Velocity Submode or the Depth Mode as input to a Bathymetric Fix Algorithm.

4. The process of claim 1, comprising:
receiving at the computer processor of the Navigation Sonar System, while the Navigation Sonar System is operating in the Alert Velocity Submode or Depth Mode, measured and computed Depth Below Surface, a time at which each depth datum was acquired, an INS indicated position, and reference map data; and
using the depth data, the INS indicated position, the reference map data, and the time of each depth datum to calculate the Bathymetric Fix.

5. The process of claim 1, comprising:
switching the Navigational Sonar System from the Alert Velocity Submode to a Depth Mode;
collecting depth data in the Depth Mode; and
using the depth data from one or more of the Alert Velocity Submode and the Depth Mode to calculate the Bathymetric Fix.

6. A machine-readable medium storing instructions, which, when executed by a processor, cause the processor to perform a process comprising:
operating a Navigation Sonar System in Alert Velocity Submode;
receiving at a computer processor of the Navigation Sonar System return data during the operation of the Navigation Sonar System in the Alert Velocity Submode; and
using depth data to calculate a Bathymetric Fix.

7. The machine-readable medium of claim 6, comprising instructions to cause the processor to perform a process comprising:
using a correlation algorithm of the Alert Velocity Submode to identify a leading edge of a first pulse in a sonar window; and
using the leading edge to calculate Receive Pulse Start Time and the associated Depth Below Keel.

8. The machine-readable medium of claim 7, wherein the use of the algorithm comprises:
determining a Depth Below Keel;
using the Depth Below Keel and a Keel Depth to establish a Depth Below Surface; and
using a series of Depth Below Surface measurements from either the Alert Velocity Submode or the Depth Mode as input to a Bathymetric Fix Algorithm.

9. The machine-readable medium of claim 6, comprising instructions to cause the processor to perform a process comprising:
receiving at the computer processor of the Navigation Sonar System, while the Navigation Sonar System is operating in the Alert Velocity Submode or Depth Mode, measured and computed Depth Below Surface, a time at which each depth datum was acquired, INS indicated position, and reference map data; and
using the depth data, the INS indicated position, the reference map data, and the time of each depth datum to calculate the Bathymetric Fix.

10. The machine-readable medium of claim 6, comprising instructions to cause the processor to perform a process comprising:
switching the Navigation Sonar System from the Alert Velocity Submode to a Depth Mode;
collecting depth data in the Depth Mode; and
using the depth data from one or more of the Alert Velocity Submode and the Depth Mode to calculate the Bathymetric Fix.

11. A system comprising:
one or more processors configured for:
operating a Navigation Sonar System in Alert Velocity Submode;
receiving at a computer processor of the Navigation Sonar System return data during the operation of the Navigation Sonar System in the Alert Velocity Submode; and
using depth data to calculate a Bathymetric Fix.

12. The system of claim 11, wherein the one or more processors are configured for:
using a correlation algorithm of the Alert Velocity Submode to identify a leading edge of a first pulse in a sonar window; and
using the leading edge to calculate Receive Pulse Start Time and the associated Depth Below Keel.

13. The system of claim 12, wherein the use of the algorithm comprises:
determining a Depth Below Keel;
using the Depth Below Keel and a Keel Depth to establish a Depth Below Surface; and
using a series of Depth Below Surface measurements from either the Alert Velocity Submode or the Depth Mode as input to a Bathymetric Fix Algorithm.

14. The system of claim 11, wherein the one or more processors are configured for:
receiving at the computer processor of the Navigation Sonar System, while the Navigation Sonar System is operating in the Alert Velocity Submode or Depth Mode, measured and computed Depth Below Surface, a time at which each depth datum was acquired, INS indicated position, and reference map data; and
using the depth data, the INS indicated position, the reference map data, and the time of each depth datum to calculate the Bathymetric Fix.

15. The system of claim 11, wherein the one or more processors are configured for:
switching the Navigation Sonar System from the Alert Velocity Submode to Depth Mode;
collecting depth data in the Depth Mode; and
using the depth data from one or more of the Alert Velocity Submode and the Depth Mode to calculate the Bathymetric Fix.
